(19) United States
(12) Patent Application Publication
(10) Pub. No.: US 2016/0171622 A1
(43) Pub. Date: Jun. 16, 2016

(54) Insurance Asset Verification and Claims Processing System

(71) Applicant: Loss of Use, Inc., Huntersville, NC (US)

(72) Inventors: Brenda Lou Perkins, Statesville, NC (US); David Mark Roberts, Weaverville, NC (US); James Markham Hall, Hollywood, CA (US); George Lewis Pollio, Beverly Hills, FL (US)

(73) Assignee: Loss of Use, Inc.

(21) Appl. No.: 14/970,439

(22) Filed: Dec. 15, 2015

Related U.S. Application Data
(60) Provisional application No. 62/092,050, filed on Dec. 15, 2014.

(51) Int. Cl. G06Q 40/08; G06K 9/60; H04N 5/232; G06T 3/40; G06T 15/20; G06K 9/20; G06K 9/62

(52) U.S. Cl. CPC G06Q 40/08; G06K 9/20; G06K 9/60; G06K 9/6298; G06T 3/4038; G06T 15/205; H04N 5/23238; G06K 2009/2045; G06K 2209/01; G06K 2009/487

(57) ABSTRACT

A user interface system for providing insurance including: a media capture unit including a camera; a controller in communication with the media capture unit; and a memory in communication with the controller; wherein the memory includes first asset information previously captured by an asset verification process in which a user captures first visual media information including at least one visual media information including an asset shown from a perspective, wherein the memory additionally including an asset verification software application that, when executed by the controller, causes the controller to: in response to receiving a notification of a loss regarding the asset, prompt the user to capture second asset information using a media prompt including directions for capturing at least one image including a view of the asset from the perspective; and transmit the second asset information to an underwriting server.

### CROSS-REFERENCE TO RELATED APPLICATIONS

This application incorporates by reference and claims the benefit of priority to U.S. Provisional Patent Application No. 62/092,050 filed Dec. 15, 2014.

### BACKGROUND OF THE INVENTION

The present subject matter relates generally to a system for insurance asset verification and claims processing system. More specifically, the present invention relates to a system for insurance asset verification and claims processing that may be accomplished by a consumer using his or her own mobile device.

When issuing insurance, the property and casualty insurance company needs to know the condition of a residential or commercial property to determine whether or not to bind coverage. Additionally, the insurance company needs to identify insurable assets prior to granting coverage for homes, commercial buildings and residential/commercial contents.

Previously, property & casualty insurance agents or third party inspection companies were tasked to collect data and photos establishing the condition of the property. The collected data was then used by the underwriter to determine whether to bind or refuse coverage to the residential or commercial property owner. To effectively estimate both risk factors relating to the asset to be insured and the attendant cost of a loss, the collected data needed to include information on the risk factors relating to the risk of loss and information regarding the value of the property. The cost of tasking property & casualty insurance agents or third party inspection companies increased the cost of providing insurance and added delay. There is a need for systems to reduce the cost and delay of traditional asset verification.

Additionally, premiums are increasingly calculated automatically using computer models. These computer models often require asset information to be provided in a structured manner, for example, using proprietary data formats including defined data fields. To provide the data in the required formats often requires manual data entry by the insurance agencies and inspectors. The need for insurance agents or third party inspections and data entry raises the cost of insurance. Additionally, because of the need to minimize the cost and bother of having an insurance agent inspecting the property, insurance companies may be limited to obtaining information they can collect in a quick and efficient manner. Thus, there is a need for tools that minimize the work required to collect asset information while maximizing the information collected.

Further, many consumers may wish to obtain a quote from multiple insurers. However, because of the cost of acquiring information for underwriting, initial premium quotes may be based on less than the full range of information that an insurance company would like when providing a premium quote. Accordingly, there is a need for tools to increase the information available to an insurance company when making a quote for an insurance premium.

Even further, when a loss occurs, the need to send a claims adjuster to begin documenting the loss and starting the claim process adds delay and cost to the claims process. There is a need for systems that reduce the delay of starting a claim and reduce the cost of collecting loss information.

Accordingly, there is a need for insurance asset verification and claims processing system, as described herein.

### BRIEF SUMMARY OF THE INVENTION

To meet the needs described above and others, the present disclosure provides insurance asset verification and claims processing system (herein “asset verification system”). The asset verification system may permit a consumer of insurance to verify her assets when applying for an insurance policy by collecting the relevant asset information using her mobile device.

To begin, the consumer may download an asset verification application from a mobile device app store and run it on her mobile device. The consumer may then follow the directions of an asset verification wizard to enter or collect needed asset information, for example, by taking photographs, or other media inputs, of important assets or of locations in the residential or commercial property to be insured. The asset verification wizard may including a series of prompts that instruct the consumer how to properly capture the asset information. Once this information is collected, it is uploaded to asset verification servers from which the insurance company is able to access and review the asset information and any associated application. Upon completion of the collection of the asset information, the asset verification system may assist in making an underwriting decision regarding whether to offer an insurance policy to the consumer and, if an offer is being made, the amount of the insurance premium.

In an embodiment, the asset information may be captured in a variety of visual, spatial, or media formats, such as images, panoramas, video walkthrough and video capture, and 3-D scans, live video streaming to an adjuster, augmented reality artificial intelligence acquisitions, light field camera array acquisitions, as well as capture via a virtual retinal display (VRD), retinal scan display (RSD), retinal projector (rp) technology or other mixed reality capture and/or acquisition device. In these various media formats, the asset information may not be interpretable by common underwriting data systems and processes. Accordingly, the system may perform an augmented reality artificial intelligence inventory (ARAII) process that analyzes the asset information in the media formats and generates new asset information in the form of Boolean (true or false) or real-valued values for specified underwriting variables, such as, number of bedrooms, square footage, personal items present, the presence of risk-factors, replacement cost and actual cash value of the home, condition of electrical, plumbing, heating and cooling systems, etc. Additionally, ARAII allows for the intelligent identification and inventory of assets. For example, by simply scanning the room from a fixed position, ARAII will identify asset types, brand, model, serial number and more, even if the items are not in plain sight and visible to the human eye, i.e. items in a drawer or closet by scanning RFID tags.

The asset verification system may also be used to initiate and verify a loss claim. For example, if the asset has suffered a loss, the consumer may use the asset verification application to notify the insurance company of the loss, and to collect needed loss documentation for verification and processing of the claim. The asset verification system may use the previously collected asset information to prompt the consumer to capture media documenting the losses incurred for inclusion in the loss documentation. The loss documentation may be provided to the insurance company. In an embodiment, the asset verification system may provide the insurance company with an estimate of the amount of loss using the loss documentation.

In an embodiment, a user interface system for providing insurance includes: a media capture unit including a camera; a controller in communication with the media capture unit; and a memory in communication with the controller; wherein the memory includes first asset information previously captured by an asset verification process in which a user captures first visual media information including at least one visual media information including an asset shown from a perspective, wherein the memory additionally including an asset verification software application that, when executed by the controller, causes the controller to: in response to receiving a notification of a loss regarding the asset, prompt the user to capture second asset information using a media prompt including directions for capturing at least one image including a view of the asset from the perspective; and transmit the second asset information to an underwriting server.

In some embodiments, the asset comprises a residential dwelling. An, in some embodiments, the media capture unit further includes a 3-D scanner, wherein the first asset information includes a 3-D scan capturing geometry of the asset. And, In some embodiments, the first asset information includes a panorama photo. Additionally, in some embodiments, upon capturing the first asset information, the controller is adapted to: classify the first asset information as sufficient or insufficient, wherein the first asset information is classified as sufficient upon successfully performing optical character recognition on a portion of the first asset information; when the first asset information is classified as insufficient, prompt the consumer to capture a further asset information of the asset.

In some embodiments, upon capturing the first asset information, the controller is adapted to: execute a statistical classifier using the first asset information as an input to receive a classification; when the classification identifies a risk factor, updating the asset information to include a data field listing the risk factor as present. And, in some embodiments, wherein, upon capturing the first asset information, the controller is adapted to: execute a statistical classifier that analyzes visual media of the first asset information to identify an asset value property of the asset shown in the visual media; updating the asset information to include a data field listing the asset value property.

In some embodiments, during an asset verification process, the controller is adapted to: prompt a user to capture first asset information regarding the asset using the media capture unit; transmit the first asset information to an underwriting server in communication with the controller. And, in some embodiments, the first asset information is captured by displaying an overlay prompt including an outline of the view to be collected, wherein the overlay prompt is displayed overlain over a camera stream.

Additionally, in some embodiments, the overlay prompt includes a prompt to capture a manufacturer's label in the first asset information. Further, in some embodiments, the overlay prompt is an outline of a water heater. Even further, in some embodiments, the overlay prompt is for an outline of a heating/cooling unit.

In some embodiments, a user interface system for providing insurance includes: an asset verification server adapted to receive asset information from a mobile device, wherein, upon receiving the asset information, the asset verification server executes a statistical classifier that analyzes visual media to identify a class of risk shown in the visual media to assign a risk factor classification, wherein, the asset verification server updates the asset information to include a data field listing the risk factor classification, wherein, after updating the asset information, the asset verification server provides the updated asset information to an underwriting server; and a mobile device comprising: a media capture unit including a camera; a controller in communication with the media capture unit; and a memory in communication with the controller, the memory including an asset verification software application that, when executed by the controller, causes the controller to: prompt a user to capture first asset information regarding the asset using the media capture unit; transmit the first asset information to the asset verification server; in response to receiving an offer from the underwriting server, display an offer screen including a quoted premium; in response to receiving an acceptance of the offer from the user interface, transmit an acceptance to the underwriting server; and in response to receiving a notification of a loss regarding the asset, prompt the user to capture second asset information using visual information derived from the first asset information.

In an embodiment, the controller is further configured to: transmit the second asset information to an underwriting server as an insurance claim; and in response to receiving acceptance of the insurance claim, displaying an acceptance of the insurance claim on the user interface. And, in some embodiments, upon capturing the first asset information, the controller is adapted to: classify the first asset information as sufficient or insufficient, wherein the first asset information is classified as sufficient upon successfully performing optical character recognition on a portion of the first asset information; when the first asset information is classified as insufficient, prompt the consumer to capture a further asset information of the asset. Additionally, in some embodiments, upon capturing the first asset information, the controller is adapted to: execute a statistical classifier using the first asset information as an input to receive a classification; when the classification identifies a risk factor, updating the asset information to include a data field listing the risk factor as present. In some embodiments, upon capturing the first asset information, the controller is adapted to: execute a statistical classifier that analyzes visual media of the first asset information to identify an asset value property of the asset shown in the visual media; and updating the asset information to include a data field listing the asset value property.

In some embodiments, during the step of prompting a user to capture first asset information regarding the asset using the media capture unit, the controller is adapted to: prompt a user to capture first asset information regarding the asset using the media capture unit; transmit the first asset information to an underwriting server in communication with the controller.

Additionally, in some embodiments, wherein the first asset information is captured by displaying an overlay prompt including an outline of the view to be collected, wherein the overlay prompt is displayed overlain over a camera stream. Further, in some embodiments, the overlay prompt includes a prompt to capture a manufacturer's label in the first asset information.

An object of the invention is to provide a solution to the cost and complexity of needing an insurance agent or third party inspector visit a property in order to make an offer for insurance.

Another object of the invention is to provide a solution to the cost and complexity of needing an insurance adjuster to visit a property in order to start the processing of a claim.

An advantage of the invention is that it provides a consumer-driven system for applying for insurance and for making claims.

Another advantage of the invention is that it provides an accurate method to set the correct amount of insurance on the residential or commercial property building and contents; thus providing the consumer with fair pricing and the insurance company with proper amount of premium.

A further advantage of the invention is that it provides a that it provides accelerated claims processing based on the joint effort of the insurer and insured which results in proper payment to insured and reduced cost to the insurer such as extended additional living expenses and adjuster hours.

An even further advantage of the invention is an educated insured plus an informed trained adjuster equals claims handling success.

Another advantage of the invention is that it documents and provides real data about condition/quality of an insurable structure.

A further advantage of the invention is that it documents and provides real data pertaining to quality and condition of contents.

Another advantage is the invention is it would eliminate the scheduling delay and inconvenience of meeting with an onsite adjuster to settle a claim.

By providing instant, real time, geo located photos of the building, the Underwriting unit could accurately set a premium without over or under valuing the risk.

A further advantage of the invention is that it educates the consumer on policy coverages, claim process and the need for third party claim representation.

The invention will provide a platform for payment of premiums through the mobile device connecting to Apple pay, Google Wallet, Samsung pay, etc.

A further advantage of the invention is providing a direct link to a temporary housing service for immediate placement in temporary housing/motel when the residence cannot be utilized.

Another advantage of the invention is that it provides a simple method for th end user to inventory all of their assets by standing in one location using ARML

A further advantage of the invention is that it provides a cost effective means for the insurance company to verify the insured's assets and to maintain a current inventory year after year.

The invention will also provide a link to connect with local, preferred vendors; when the insured structure needs to be secured or covered by a tarp after a fire.

A further utilization of the invention will allow the insurance carrier to direct the insured (with their smart device) to specific or damaged areas with the use of an Augmented Reality (AR) helmet, goggles, or smart glasses. The video stream will broadcast to the insurance carrier from the AR helmet, goggles or smart glasses and eliminate an onsite visit from the Carrier.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a diagram illustrating an example of insurance asset verification and claims processing system.

FIG. 2A is a diagram illustrating an example mobile device including an asset verification application of the system of FIG. 1.

FIG. 2B is a diagram illustrating an example asset verification server of the system of FIG. 1.

FIG. 3 is an example wizard overview screen of the asset verification application to enable a consumer to collect asset information for an asset for verification by the system of FIG. 1.

FIG. 4A is an example prompt screen of the asset verification application to enable a consumer to collect media documenting the asset to include in the asset information.

FIG. 4B is an example panorama screen of the asset verification application to enable a consumer to collect a panorama documenting the asset to include in the asset information.

FIG. 4C is an example scan selection screen of the asset verification application to enable a consumer to select between a room scan and an object scan.

FIG. 4D is an example object scan screen of the asset verification application to enable a consumer to 3-D scan a content object.

FIG. 4E is an example real-time augmented reality artificial intelligence inventory scan screen of the asset verification application to enable a consumer to inventory the content objects in a room in real-time.

FIG. 5 is a diagram illustrating an example of the steps for processing collected media to determine risk factors and asset value information for the asset.

FIG. 6A is an example of an underwriting report including the asset information for use in making an underwriting decision.

FIG. 6B is an example of an offer screen of the asset verification application including an offer for insurance for the consumer 20.

FIG. 7A is an example of a claims menu screen of the asset verification application to permit the consumer to start and manage a claim.

FIG. 7B is an example of a file claim screen of the asset verification application to permit the consumer to start a claim.

FIG. 7C is an example of a report damages screen of the asset verification application to permit the consumer to collect documentation of a claim.

FIG. 8A is an example loss capture screen of the asset verification application that may be used by a consumer to capture media for loss documentation when making a claim. FIG. 8A includes an example prompt layer of FIG. 8B overlaid over a camera stream of FIG. 8C.

FIG. 8B is an example prompt layer of the asset verification application that may be overlaid over a camera stream in the loss capture screen to indicate to a consumer how to properly capture media illustrating the damage to the asset.

FIG. 8C is an example camera stream of the asset verification application that may be displayed in the loss capture screen to illustrate the current camera view.

### DETAILED DESCRIPTION OF THE INVENTION

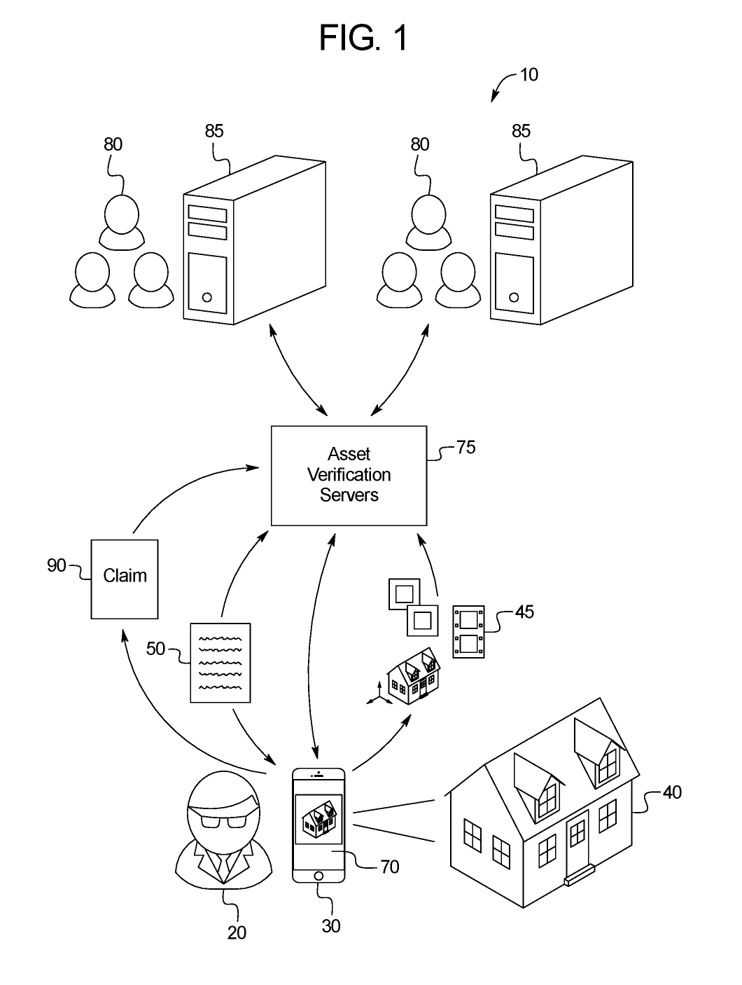

FIG. 1 illustrates an example of insurance instant asset verification and claims processing system (herein, the asset verification system 10). As shown in FIG. 1, the asset verification system 10 may permit a consumer 20 of insurance to verify her assets 40 when applying for an insurance policy 50 by collecting the relevant asset information 45 using her mobile device 30. Assets 40 may include a residential dwelling, detached structures, commercial property, the contents of dwelling or business, etc. As used herein, mobile device 30 may refer to a smart phone, tablet, smart glasses, augmented reality headsets, holographic acquisition devices, light field camera array capture devices, or any other portable computing platform with a camera, a 3-D scanner or other visual or spatial media capture acquisition method, as will be understood by those of skill in the art from the examples provided. The consumer 20 may download an asset verification application 70 from a mobile device app store and run it on her mobile device 30.

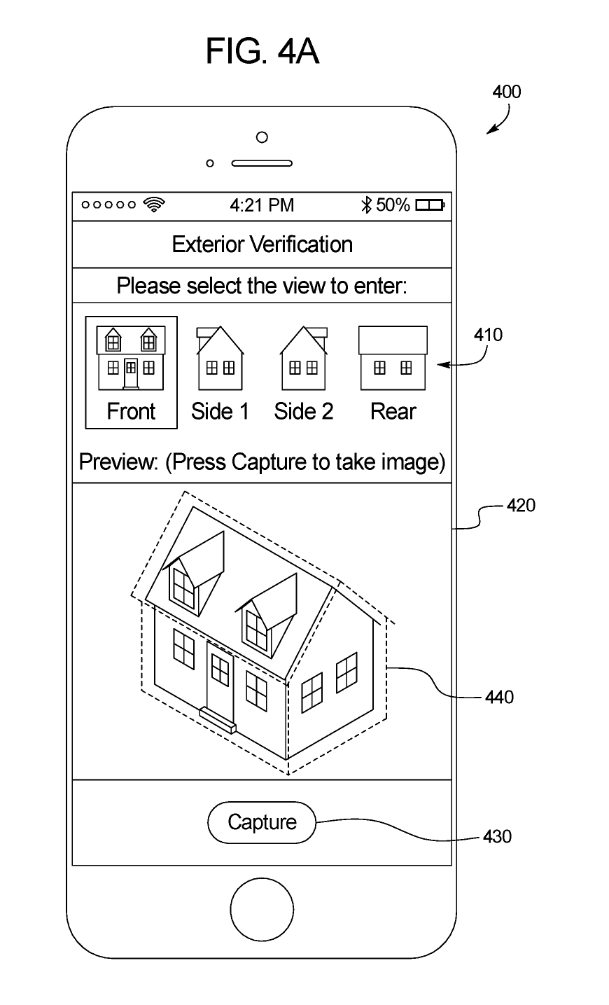

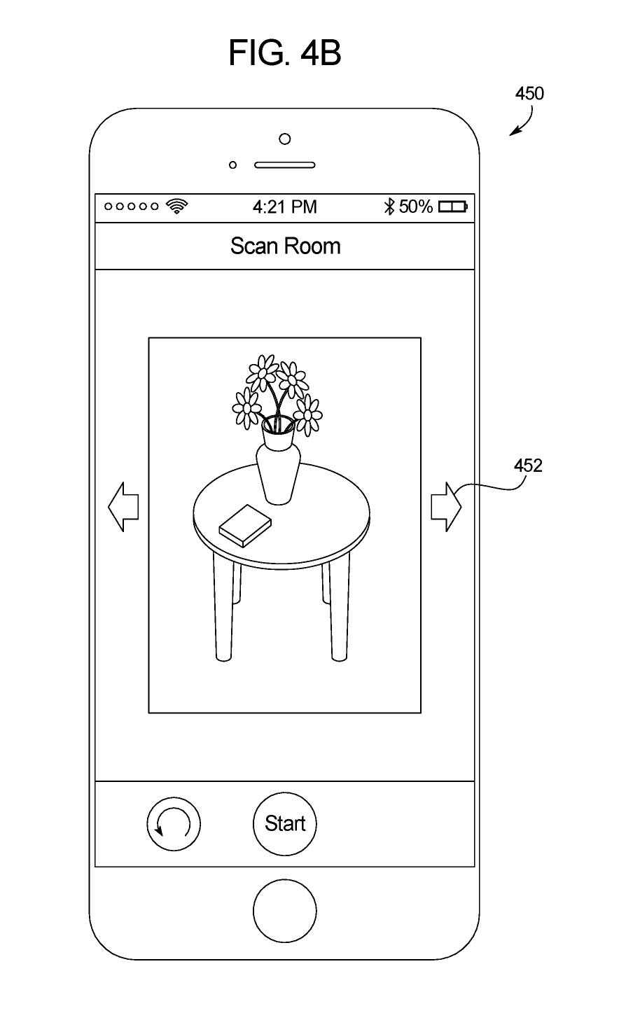

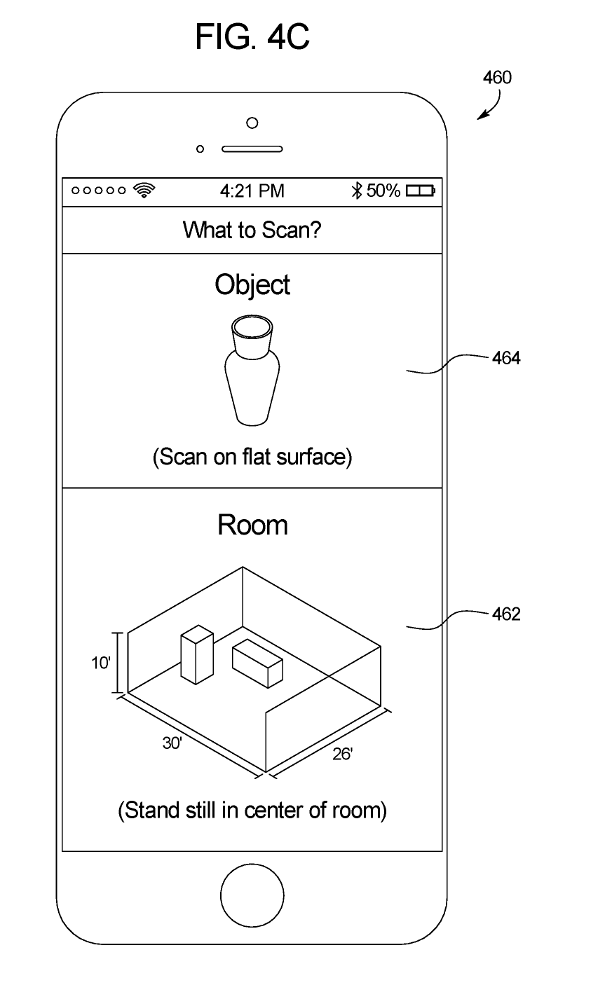

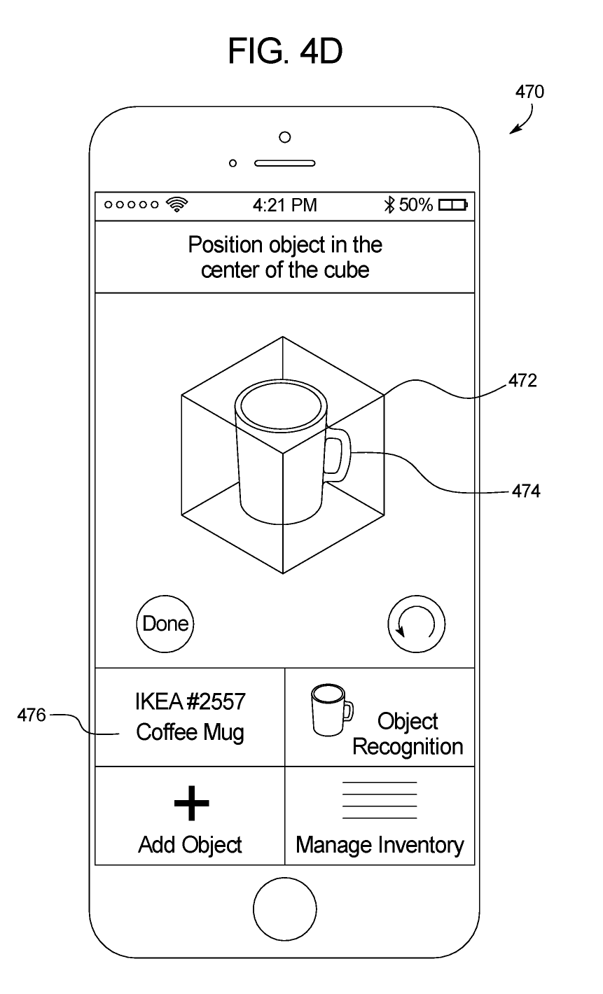

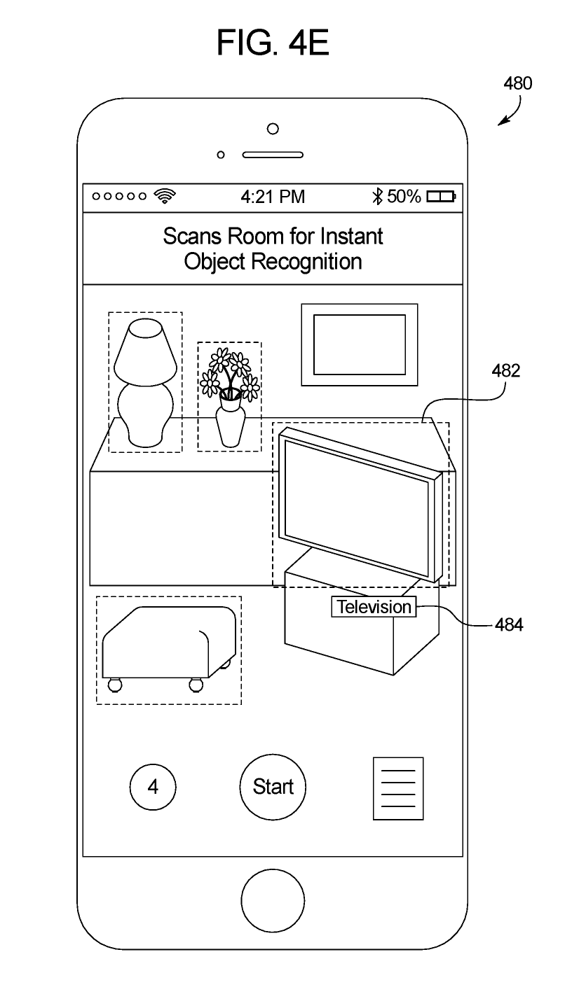

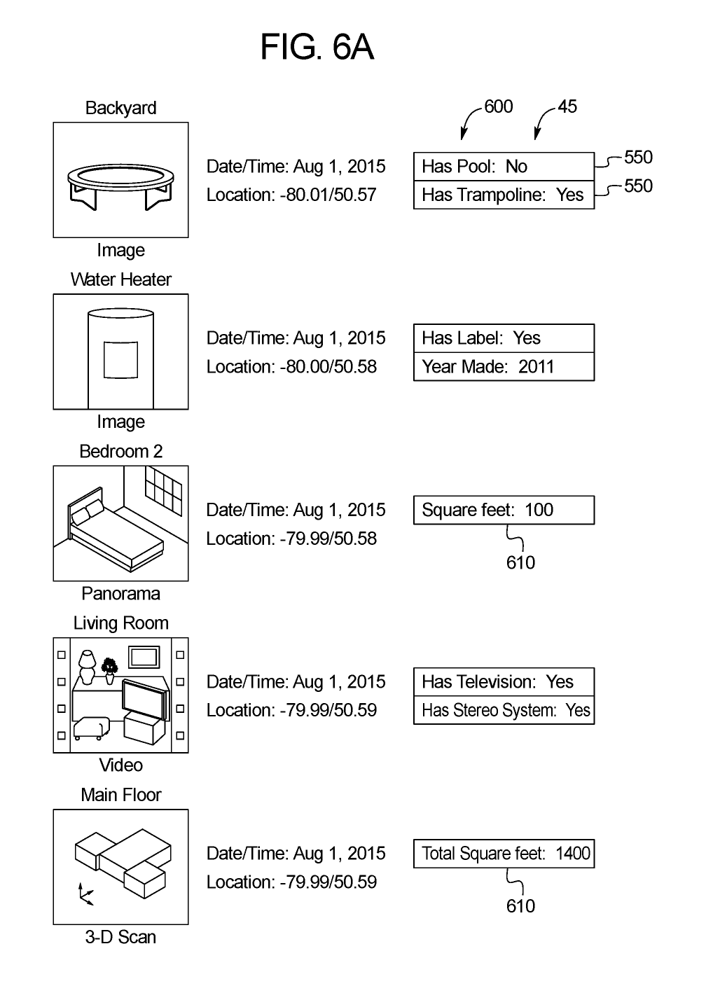

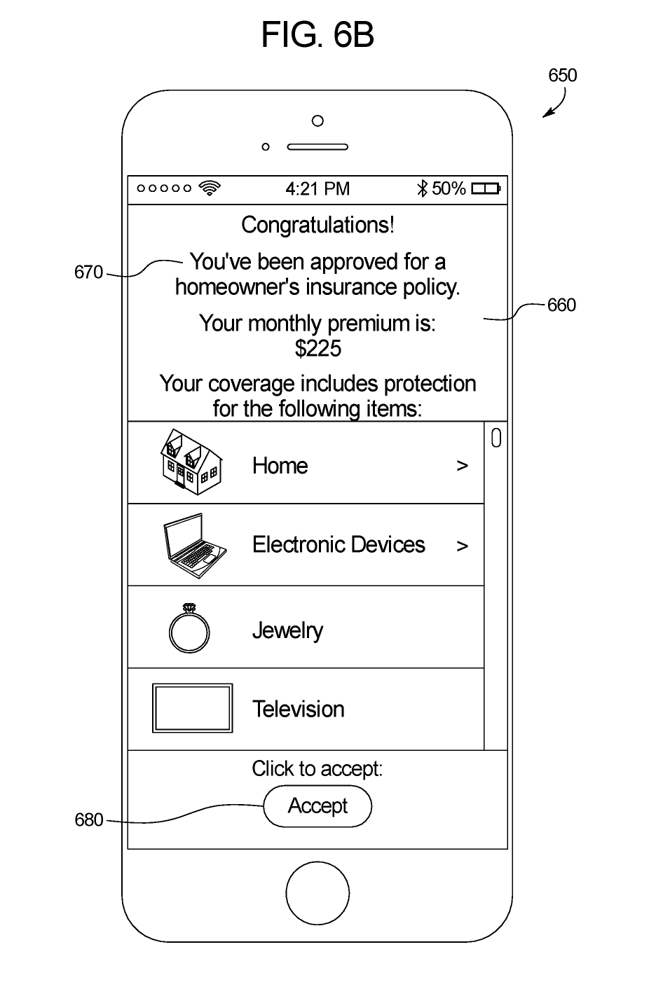

The consumer 20 may then follow the directions of an asset verification wizard to enter or collect needed asset information 45, for example, by taking photographs, or other media inputs, of important assets 40 or of locations in the residential or commercial property to be insured. The asset verification wizard may include a series of prompts 410 (FIG. 4) that instruct the consumer how to properly capture the asset information 45. Upon completion of the collection of the asset information 45, the asset verification system 10 may make an underwriting decision regarding whether to offer an insurance policy 50 to the consumer 20 and, if an offer 650 (FIG. 6B) is being made, the amount of the insurance premium. The consumer 20 may then purchase an insurance policy 50 within the asset verification application 70 using a variety payment means, such as, Paypal®, Google Wallet®, Apple Pay®, Samsung Pay® or a credit card. After the purchase, the asset verification application 70 may permit the viewer to view the policy and the policy number.

In an embodiment, the asset information 45 may be captured in a variety of visual, spatial, or media formats, such as images, panoramas, video walkthrough, live video stream, and 3-D scans. In these various media formats, the asset information 45 may not be interpretable by common underwriting data systems and processes. Accordingly, the system 10 may perform an augmented reality artificial intelligence inventory (ARAII) process that analyzes the asset information 45 in the visual media formats and generates new asset information 45 in the form of Boolean (true or false, or, in some examples, present or not present) or real-valued values for specified underwriting variables, such as, number of bedrooms, square footage, personal items present, the presence of risk-factors, value of the home, condition of electrical, plumbing, heating and cooling systems, the content items in the asset 40, etc.

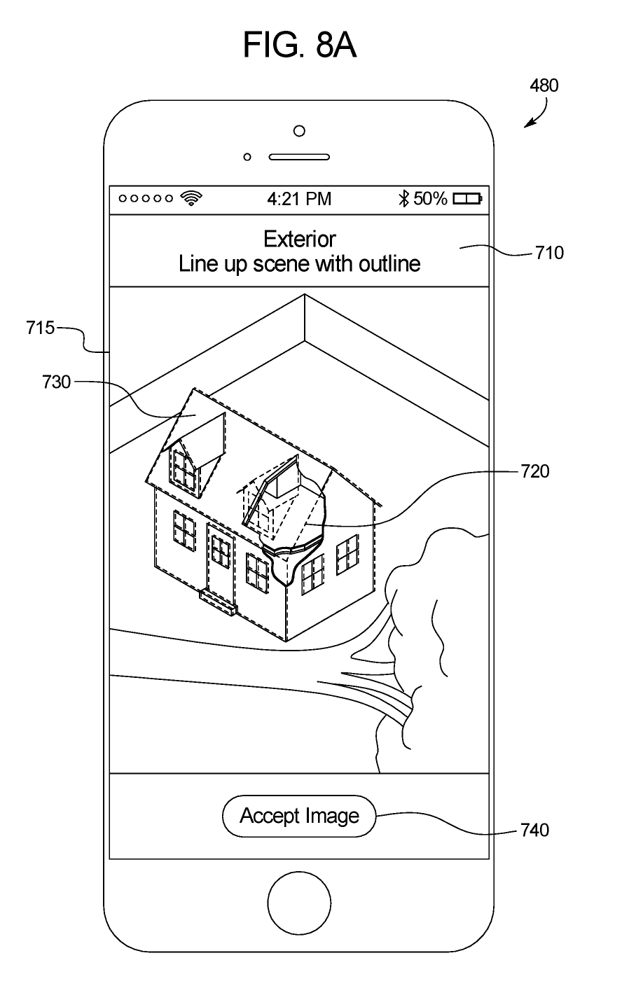

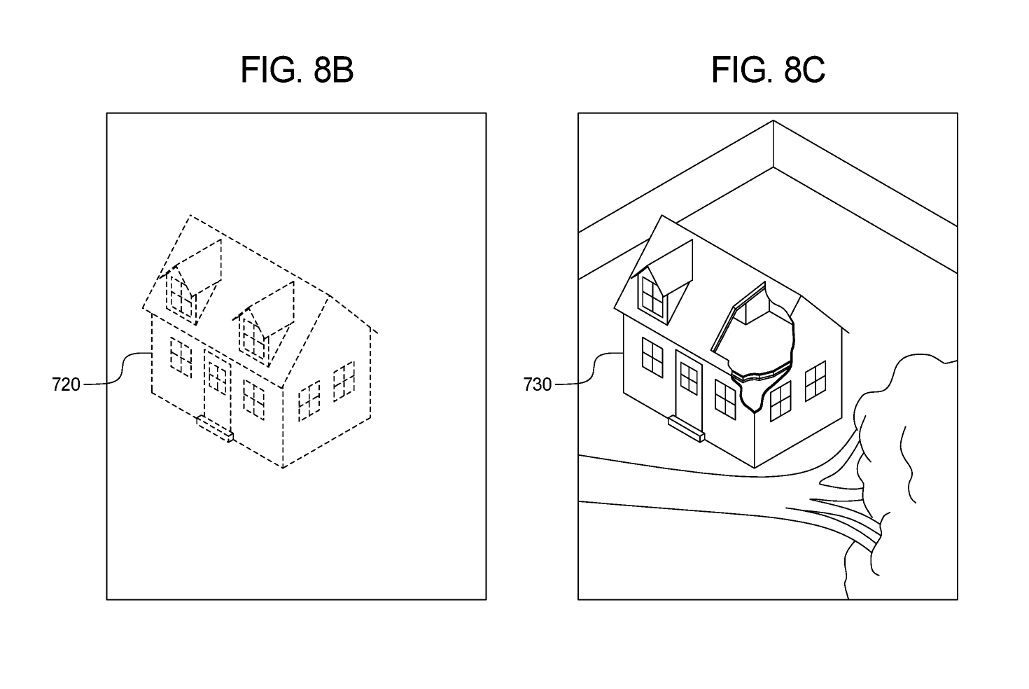

The asset verification system 10 may also be used to initiate and verify a loss claim 90. For example, if the asset 40 has suffered a loss, the consumer 20 may use the asset verification application 70 to notify the insurance company of the loss, and to collect needed loss documentation 850 (FIG. 8A) for verification and processing of the claim 90. The asset verification system 10 may use the previously collected asset information to prompt the consumer 20 to capture media documenting the losses incurred for inclusion in the loss documentation. The loss documentation 850 may be provided to the insurance company 80. In an embodiment, the asset verification system 10 may provide the insurance company 80 with an estimate of the amount of loss using the loss documentation 850.

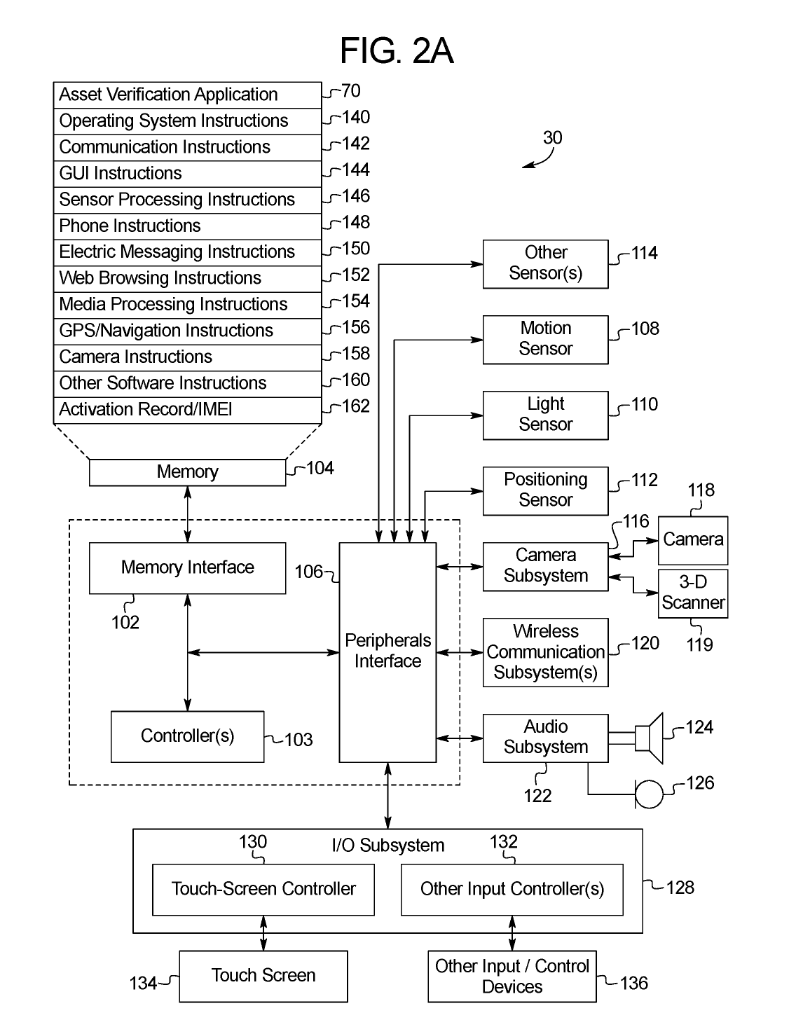

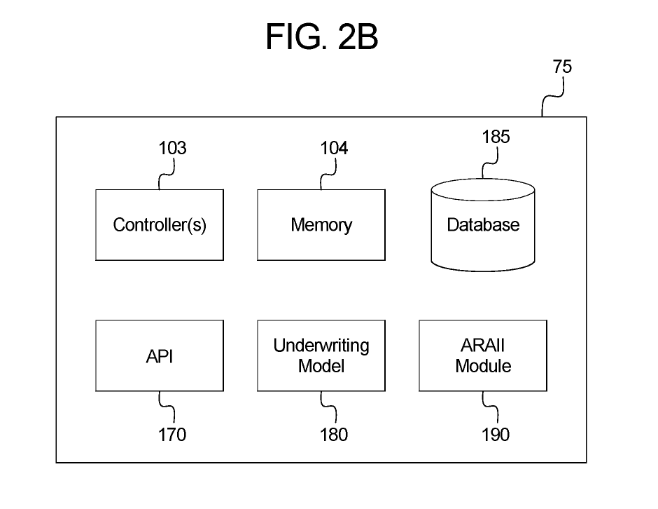

The asset verification application 70 may be provided on a computer-readable medium and installed on the mobile device 30, as shown in FIG. 2A. The mobile device 30 may include a media capture unit including a camera 118, 3-D scanner 119, or other media capture devices to enable the collection of media. Additionally, in some embodiments, a light field camera array system such as the Lytro Immerge® may also be used to facilitate capture performed by consumer 20 for review by insurance company 80. Further, hand tracking technology such as that found in Leap Motion systems, may be used to navigate through the application 70 as well as controls for asset information capture.

The asset verification system 10 may include asset verification servers 75 that may receive data collected by the asset verification application 70 and store. The asset verification system 10 may additionally include or communicate with insurance company servers 75. In some embodiments, the consumer 20 may access the asset verification servers 75 over the web. It is contemplated that any or all of the functionality of the asset verification application 70 may be embodied in a web site of the asset verification servers 75.

The asset verification application 70 may be provided by an insurance company, or by a third-party asset verification provider. The asset verification application 70 may communicate with the asset verification servers 75. The asset verification servers 75, may, in turn, communicate with the insurance company servers 85 to provide collected asset information 45 from the asset verification application 70 to the insurance company servers 75.

FIG. 2B is a diagram illustrating an example asset verification server of the system of FIG. 1. The asset verification application 70, the asset verification servers 75, and the insurance company servers 85 may cooperate to make underwriting decisions as described herein. For example, the insurance company servers 85 may communicate with the asset verification servers 75 through an application programming interface (API 170). Through the API 170, the insurance company servers 85 may receive the asset information 45 from the asset verification servers 75. The asset information 45 may be used to generate an underwriting decision and/or a premium for the desired coverage.

The insurance company servers 85 may use the collected asset information 45 to make underwriting decisions. The asset verification system 10 may include a user interface to permit the insurance company 80 to specify the asset information 45 needed for receiving an offer 650 from that insurance company 80. Upon receiving the asset information 45 from a consumer 20, if the consumer 20 qualifies, the consumer 20 may then be offered an insurance policy 50. In some embodiments, the asset verification application 70 may provide the asset information 45 to multiple insurance companies, each of which may perform the underwriting process and, at their discretion, offer an insurance policy 50 to the consumer 20.

Asset information 45 may include any information needed to make an underwriting decision. For example, asset information 45 may include photographs of real estate property and personal property assets 40. Asset information 45 may include the answers to questions about the asset 40, for example, for real property, the asset information 45 may include the number of bedrooms, square feet of space, the presence or absence of a garage, the location of the property, etc. As another example, for personal property, the consumer 20 may be asked to provide an age of the real property, an estimated value, etc. Asset information 45 may be provided as Boolean data, real valued data, free-form text, media files, (including images, video, photos, and 3D scans), etc.

In various embodiments, the asset verification application 70 may request the consumer 20 to collect asset information 45 in one or more of a variety of different visual, spatial, or media formats. For example, in some embodiments, the asset verification application 70 may request still photos or images of various views of the asset 40. In another embodiment, the asset information 45 requested may be provided as three-hundred-sixty degree panoramic photos of views of the asset 40. In yet another embodiment, the asset verification application may collect the asset information as a 3-D scan of various aspects of the asset 40. A 3-D scan may include both 3-D models of the asset 40 along with model textures that may include detail of the asset 40.

The collected asset information 45 may be used to generate an augmented reality artificial intelligence inventory (ARAII) of the assets. The ARAII may include an inventory of assets 40 of the consumer determined by the asset verification system 10 using artificial intelligence or machine learning techniques, as described herein. The ARAII may additionally inventory risk factors for an asset 40, information useful to estimate the value of the asset 40, and other information useful for underwriting, for example, the presence of pets, trampolines, pools, etc., that may be useful when making an underwriting decision. In an embodiment, the ARAII may be provided to the insurance company servers 85 to assist the generation of an insurance underwriting decision.

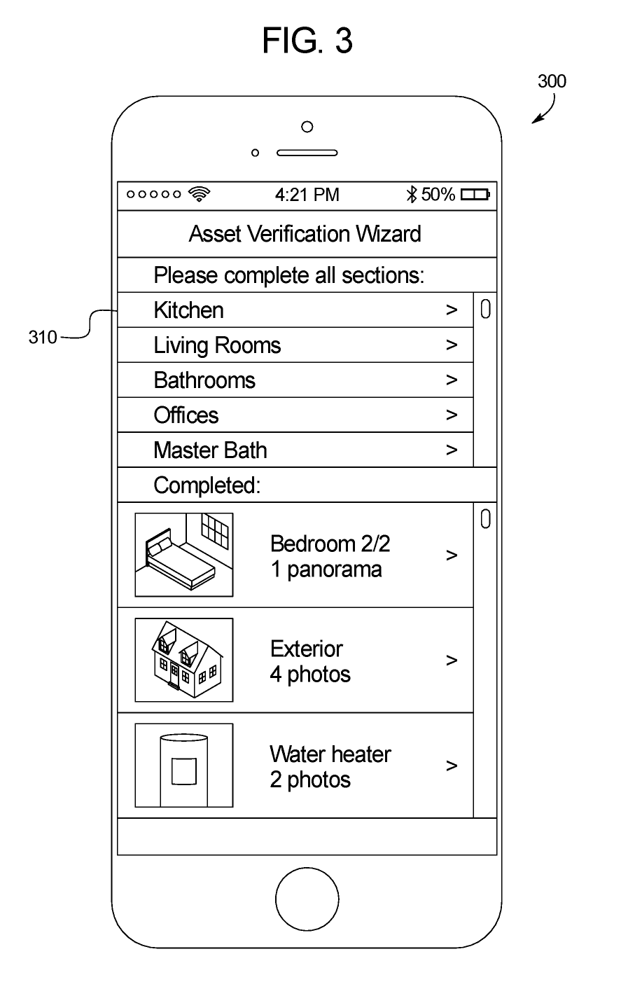

In an embodiment, when applying for insurance, the consumer 20 may begin using the asset verification wizard in a wizard overview screen 300 shown in FIG. 3. From this screen, the consumer 20 may proceed through a list of prompts 310 for desired asset information 45 to collect. For example, the wizard overview screen may include a list of asset information types or asset views desired such as, locations, angles, etc. from which to capture images, 3-D scans, etc., of the asset 45. A consumer 20 may select from the list of prompts 310 to input asset information 45 for a prompt 410.

When the consumer 20 opens the prompt 410, a prompt screen 400 may be displayed to prompt the consumer 20 to input the asset information 45. For example, if the asset 40 to be insured is a residential home, the consumer 20 may be prompted to take photographs of the exterior of the home. The prompt screen 400 may include a description of the asset information 45 to be collected, such as the front face, side faces, and the rear of the home. The prompt screen 400 may include a feed 420 from a camera 118 of the mobile device 30 illustrating the current view from the camera 118. The prompt screen 400 may include a capture button 430 that the consumer 20 may press to capture an image. The captured image may be time and location stamped and added to the asset information 45 stored in the mobile device 30 using GPS coordinates to confirm the consumer's location. To assist the consumer 20 in the collection, an overlay prompt 440 such as gridlines, or an outline of an example of the view to be collected, may be displayed. For example, when capturing an image of the front of a house, an example outline of a home may be overlaid on the feed to guide the user to center, align and position the view of the home for proper capture. After the image is captured, the image may be displayed to the consumer 20 and the consumer 20 may choose to accept the image or to retake the image, as needed. As noted, when each piece of asset information 75 is collected, the application may additionally collect time stamp information and geo-location information using cell phone tower triangulation and/or GPS signals. The time stamp information and the geo-location information may be associated with the image in the asset information 45.

It is contemplated that the list of prompts 310 may request the collection of asset information 45 for the building structure including: perspective photos elevations; roof condition/type; kitchen cabinets, counters and appliances; each bathroom. Additionally, the list of prompts 310 may request the collection of asset information 45 for pets, and also for electrical devices of the property, such as, an interior of an electrical panel, a water heater, heating/cooling units, etc. For each electrical device, the asset verification application 70 may prompt the user to capture Manufacturer's ID Plates, or other information bearing labels on the electrical devices. The system 10 may identify the type of electrical device, the sub-type of electrical device (for example, whether a water heater is gas or electric), etc.

In another embodiment, as shown in the panorama screen 450 of FIG. 4B, the asset verification application 70 may receive asset information in the form of panorama photos. Upon opening the prompt screen 400, the consumer 20 may be prompted to move from room-to-room taking the panoramas. The prompt screen 400 may display an animation 452 illustrating that the consumer 20 is to move as close to the center of the room as possible and to slowly sweep the camera 118 around to capture a full view of the room. The consumer 20 may additionally be prompted to capture images of areas not captured by the panorama, such as the ceiling and the floors, and the insides of closets and drawers.

In another embodiment, the asset verification application 70 may receive asset information 45 in the form of video. Upon opening the prompt screen 400, the camera 118 may begin recording a video stream from the camera and displaying the video stream on the screen 134. The video stream may be stored locally and uploaded to the asset verification servers 75. The prompt screen 400 may include a capture button 430 on the prompt screen 400 when the desired view of the asset 40 is viewable within the prompt screen 400. For example, if the prompt is “Master Bathroom”, the consumer 20 may proceed to the Master Bathroom, position the view appropriately and press the capture button 430. In response to pressing the capture button 430, the video stream may be marked at that time point as showing the Master Bathroom. Additional information, such as a timestamp and GPS stamp may be additionally associated with the video capture and added to the asset information 45.

In yet another embodiment, the asset verification application 70 may receive asset information 45 in the form of a 3-D scan. A 3-D scan may be performed by a 3-D scanner 119 built into the mobile device 30, or using an add-on device such as a Structure Sensor marketed by Occipital®. A 3-D scanner 119 may use laser light, cameras, etc. to create a three-dimensional geometric pattern of a space, such as a room. The 3-D scanner 119 may create a model of the interior of a residential dwelling that includes both the geometric shape of the space along with textured images of the walls and objects within the space. The 3-D scanner 119 may additionally create models of content items, such as personal property, business equipment, etc. As shown in a scan selection screen 460 of FIG. 4C, the consumer 20 may choose to scan the interior of a room or space using a room scan 462 or an object scan 464 to scan content items.

The asset verification application 70 may receive the model from the 3-D scanner 119. The 3-D scanner 119 may be operated while the consumer 20 is on the prompt screen 400. The consumer 20 may be prompted to move from location to location to capture various locations and views of the asset 40. When the consumer 20 has moved to the appropriate location for a prompt, the consumer 20 may press the capture button to initiate the 3-D scan for the location. The 3-D scan may be added to the asset information 45 and time and location stamped.

As shown in FIG. 4D, when performing an object scan in an object scan screen 470, the consumer 20 may be instructed to center the content object 472 within an on-screen animation 474. The on-screen animation 474 may update based on the consumers 20 movement around the object 472. For example, as shown, the animation 474 may include a box within a sphere. As the consumer 20 moves, the box may rotate so as to stay at fixed location if the consumer 20 is correctly moving the camera 118. If the consumer 20 fails to move correctly, the object 472 will not remain within the box. In this way, the animation 474 may provide immediate feedback to the consumer 20 to ensure correct motion of the camera 118. The mobile device 30 may identify the object 472 using the ARAII module 190 and display the name of the object 476.

Turning to FIG. 4E, shown is a real-time ARAII screen 480. As shown in the a ARAII screen 480, an augmented reality artificial intelligence inventory may be performed as the consumer 20 collects media using the mobile device 30. The real-time ARAII may be performed using the raw camera feed, a raw 3-D scan feed, or any other sensor input of the mobile device 30. Each identified object may be labeled with a bounding box 482 and a label 484. The objects detected in the real-time ARAII scan may be added to the asset information 45. The real-time ARAII may be performed by an ARAII module 190 of the mobile device 30 or by streaming the collected data to an ARAII module 190 of the asset verification servers 75. The results of the ARAII may be added to an underwriting report 600 for use by the insurance company 80 when evaluating a consumer 20 for a new or existing insurance policy 50.

In some embodiments, the asset verification application 70 may include a sample picture of each desired asset view. For example, if the asset view requested is a location such as a garage, the sample picture may illustrate an image of the garage taken from outside the open garage door with the cars removed from the garage. The consumer 20 may then capture a photograph of the garage as shown. The asset verification application 70 may request multiple views for each location. For each view, the asset verification application 70 may include a sample picture illustrating the perspective to be captured.

Upon receiving an input of a piece of the asset information 45 in a visual spatial, or media format, the asset verification system 10 may verify the quality of the asset information 45. For example, if the piece asset information is an image, the system 10 may verify that the asset 40 is included in the image, that the image is not blurry or out of focus, that the image is adequately lighted, etc. If the asset information 45 is determined not to be acceptable, the consumer 20 may be prompted to re-acquire the asset information 45.

Once the consumer 20 has completed the asset information collection using the asset verification application 70, the consumer 20 may be prompted to check back later and/or to anticipate an alert once approval has been decided. The asset verification application 70 may demonstrate a unique sound, voice prompt, email notification, holographic alert, and/or SMS that the application 70 will play to notify the consumer 20 when a decision has been made. The collection of the asset information 45 being completed, the system 10 may perform the augmented reality artificial intelligence inventory.

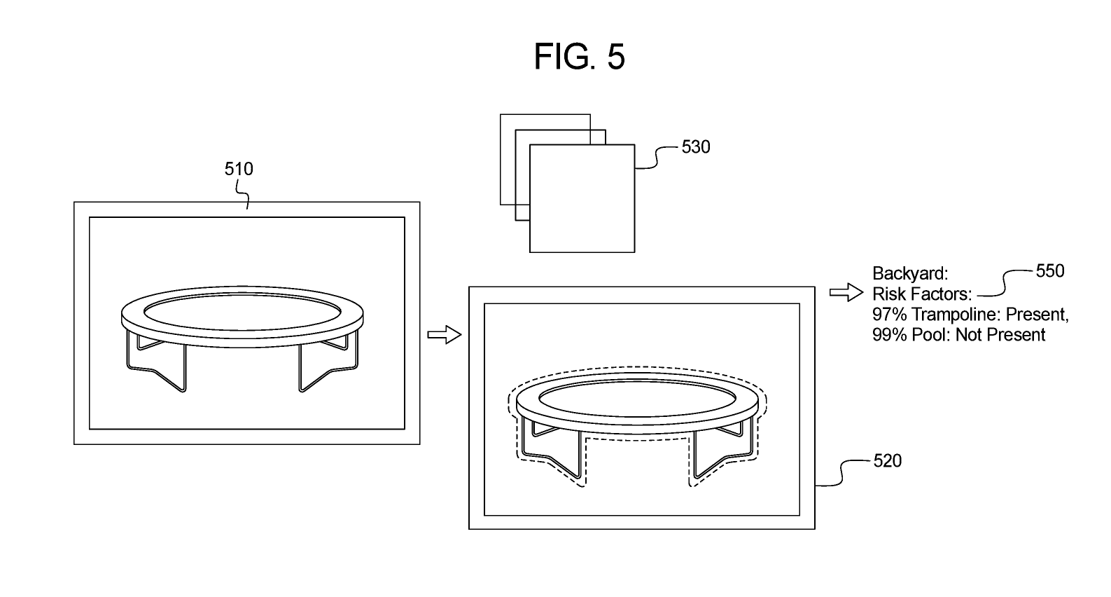

Turning to FIG. 5, shown is a diagram illustrating an example of the steps of the ARAII for processing collected media to determine risk factors 550 and asset value information 610 for the asset 40. An ARAII module 190 of the asset verification server 75 may perform the augmented reality artificial intelligence inventory. In other embodiments, an ARAII module 190 in the mobile device 30 may perform the augmented reality artificial intelligence inventory.

FIG. 5 illustrates the process of extracting risk factors 550, asset value information, etc. during the augmented reality artificial intelligence inventory. When performing the ARAII, the media asset 510 may be input into one or more statistical classifiers 520. The statistical classifier 520 may classify the media asset 510 to output one or more output classifications including risk factors 550, asset value information, 610 etc.

In an embodiment, the statistical classifiers 520 may be machine-learning models, such as a deep learning convolution neural network using multiple layers of individual neurons. The convolutional neural network may be a feed-forward artificial neural network where the individual neurons are tiled such a way that they respond to overlapping regions in the visual field. The individual neurons may be rectified linear units. Additionally, the statistical classifiers 520 may include pooling layers compute the max or average value of a particular feature over a region of the image.

The statistical classifiers 520 may be trained using supervised training. For example, the statistical classifiers 520 may be trained using a training database of previously classified images wherein each training image is labeled with one or more risk factors 550 or asset value information. For example, the training data may be drawn from the underwriting database of images and data about previously underwritten assets 40. Using the labeled training data, the statistical classifier 520 may be trained by applying the backpropagation algorithm, to calculate the gradient of a loss function with respect to all the weights in the neural network. Backpropogation may be used in conjunction with an optimization method such as gradient descent. In an embodiment, the dropout method may be use to prevent overfitting. For example, at each training stage, individual nodes are either “dropped out” of the net with probability 1-p or kept with probability p, so that a reduced network is left; incoming and outgoing edges to a dropped-out node are also removed. Upon completion of the training of the statistical classifiers 520, the statistical classifiers 520 are adapted to provide a classification for a provided input media asset 510.

As a part of the ARAII, the system 10 may verify the presence of items or information in the collected asset information 45. For example, an insurance company 80 may require the collection of information regarding the electrical breaker for a homeowner's policy. The asset verification application 70 may prompt the consumer 20 to capture an image of the electrical panel. The system 10 may then analyze the image to classify the electrical panel as a circuit breaker type or a fuse type. The asset information 45 may then be updated to include a determination of the electrical panel type. For example, the asset information 45 may include a data field for the electrical panel that indicates whether the electrical panel is a circuit breaker type or a fuse type. This field may be set by the system 10 upon performing the ARAII.

Additionally, as a part of the ARAII, the system 10 may inventory risk factors that may affect the likelihood of a future claim. For example, during the ARAII, the system 10, may detect signs of water damage on the walls or roofs of rooms as captured in asset information 45 in visual, spatial, or media formats. Accordingly, a Boolean data field of the asset information 45 may be updated to indicate the presence of water damage. As another example, during the ARAII, the system 10 may detect roof pattern anomalies, such as missing shingles of falling gutters, and a Boolean data field of the asset information 45 may be updated to indicate missing shingles, falling gutters, or both.

Once all the required asset information 45 is collected, and the ARAII performed (in some embodiments), the system 10 may generate an underwriting report 600 as shown in FIG. 6A. The underwriting report 600 may include the collected asset information 45, including data in various media formats, such as still photos, 360 degree panoramic photos, and 3-D scans, light field camera acquisitions, and data fields derived from the photos and scans, etc. The underwriting report 600 may include Corelogic® information to further flag risk issues and current fire protection class. Additionally, the underwriting report may be customized to each insurance companies preferred outside vendor links to facilitate underwriting decisions, such as Verisk® or Eagleview®, to provide oblique aerial photos to calculate roof squares, wall dimensions, etc. The underwriting report may be provided to the insurance company, for example, via the insurance company servers.

In some embodiments, the system 10 may assist in the underwriting process. For example, the asset verification servers 75 or the insurance company servers 85 may review the asset information 45 and/or the underwriting report 600 to make an underwriting decision. For example, the asset information 45 may be processed using an augmented reality artificial intelligence inventory to determine various risk factors 550 and asset value information 610. The risk factors 550 and asset value information 610 may then be fed into an actuarial underwriting model 180 that may decide whether to offer insurance and at what premium 675. Alternatively, in some embodiments, the asset information, underwriting report, risk factors, asset value information, etc., may be provided to an underwriter to make the underwriting decision.

Upon the determination to provide insurance to the consumer 20, the asset verification application 70 may receive a notification from the asset verification servers 75 and/or the insurance company servers 85. The asset verification application 70 may play the unique sound and display a notification to the consumer 20 that insurance coverage is being offered and at the premium it is being offered at. The consumer 20 may then be permitted to accept or reject the insurance coverage.

As shown in FIG. 6B, the asset verification application 70 may display an offer screen 500 illustrating details of the offer 660 from the insurance company 80. The offer screen may display the offer decision 670 indicated whether the consumer 20 is approved. If the consumer 20 is approved, as shown, the offer screen 500 may include the quoted premium 675. The offer screen may additional view a list of covered property 680 included in the policy along with any terms and conditions, limitations, etc. The consumer 20 may press an accept button 690 to accept the offer 670 and accept the offered insurance policy 50.

After the consumer 20 is insured, the asset verification application 70 may request annual renewal asset verification every year, and require the consumer 20 to complete some or all of the asset verification steps described herein. For example, the consumer 20 may be required to update residential and/or commercial property photos for the annual policy renewal.

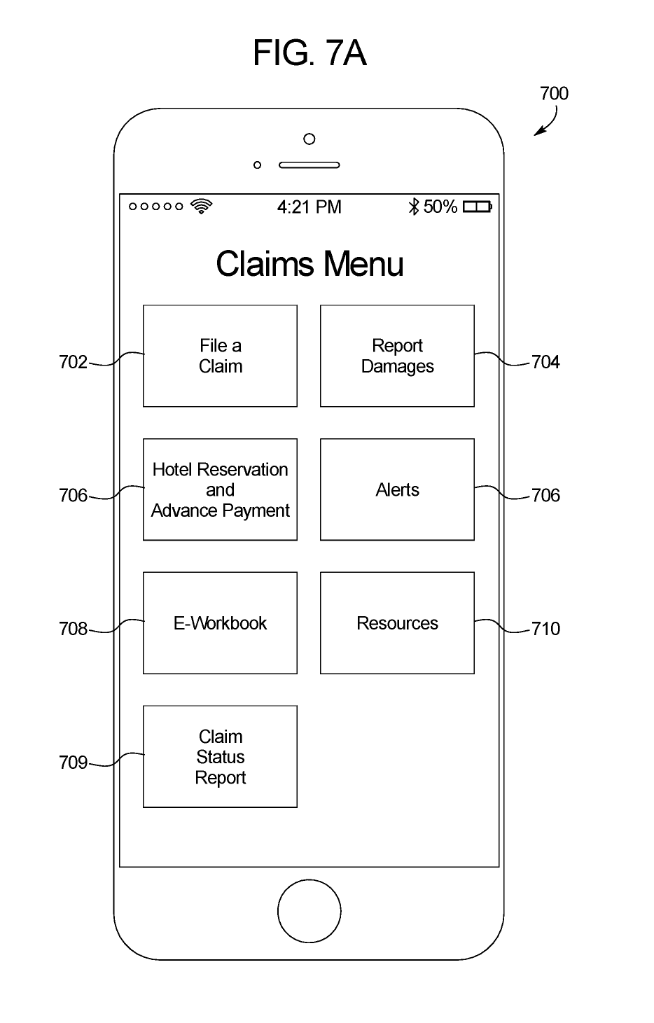

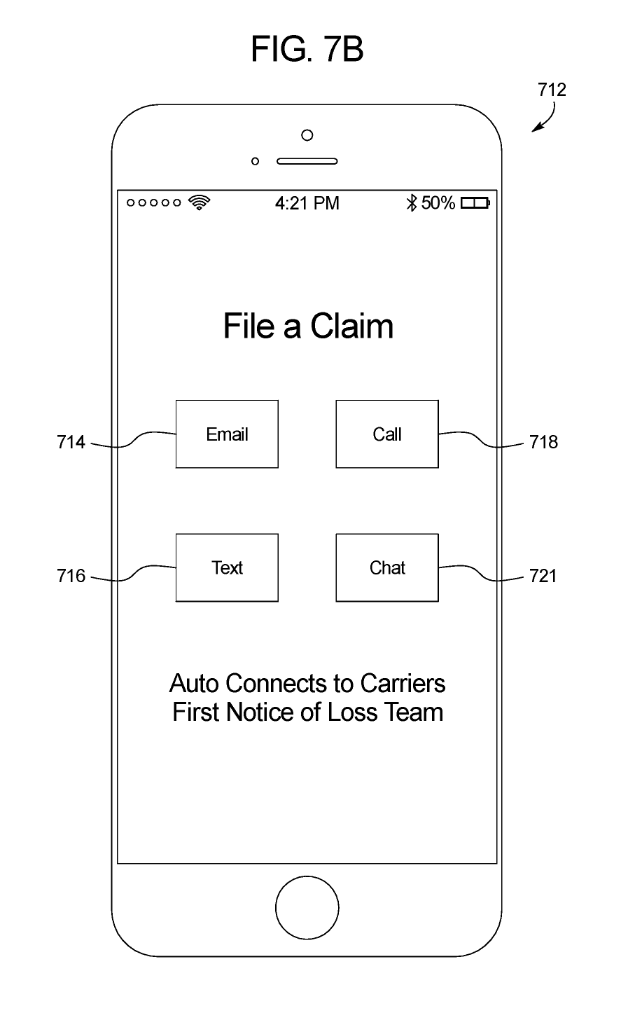

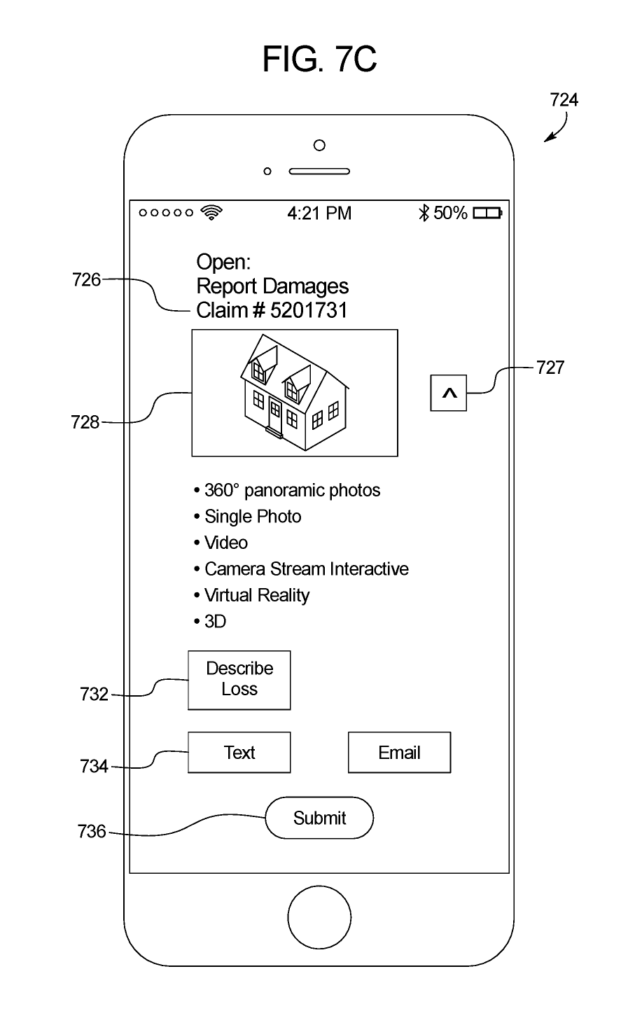

Additionally, the consumer 20 may use the asset verification application 70 to initiate a claim. To document the claim, FIG. 7A illustrates a claims menu 700 that a consumer 20 may access to begin the claims process. As shown, the consumer 20 may select between a file a claim button 702, a report damages button 704, a hotel and advance payment button 706, an alerts button 706, an e-workbook button 708, and a resources button 710.

When the consumer 20 presses the file a claim button 706, the consumer 20 may be taken to a file claim screen 712 shown in FIG. 7B. In the file claim screen 712, the consumer 20 may select from a variety of ways to contact the first notice of loss team of the insurance company 80. For example, the consumer 20 may select the email button 714 to open an email application to send an email. The email may be prepopulated with the insurance companies' claim email address in the send field, and the policy number in the subject line. Likewise, if the consumer 20 chooses the text button 716, a text application may be opened with a text to the insurance company 80 prepopulated with the consumer's policy number. If the consumer 20 wants to call the insurance company 80, the consumer 20 may select the call button 718, to open a phone application with the insurance companies phone number prepopulated. A running banner may be displayed over the screen with the consumer's policy number. Even further, the consumer 20 may choose to initiate a live video chat with the first notice of loss team by pressing the chat button 721. The application 70 may transmit the consumer's policy number to the operator of the live video chat. Once the consumer 20 contacts the insurance company 80 using the asset verification application 70, the insurance company servers 85 may transmit a claim number to the application 70.

When the consumer 20 presses the report damages button 704, the consumer 20 may be taken to a report damages screen 724. The report damages screen 724 may include a claim number 726. The consumer 20 may enter loss documentation 850 by clicking add button 727 to launch the loss capture screen 800 of FIG. 8. After entry, image thumbnails 728 of the loss documentation 850 may be displayed on the report damages screen 724. The report damages screen 724 may list the media types for which the loss documentation 850 may be provided. The consumer 20 may enter a written description of damage by pressing a describe loss button 732. It is contemplated that the consumer 20 may use voice recognition software and speech to text technology for this and any data input tasks of the present disclosure. Additionally, the consumer 20 may toggle between sending a report of the damages via text or email using a toggle 734. Once, the report of damages is complete, the consumer may press a submit button 736 to have the report of the damages sent to the asset verification servers 75 or the insurance company servers 85 where the report and all associated data is stored.

The insurance company 80 may use the report of damages to determine and facilitate claim settlement applicable to structure, content loss and ALE report. The insurance company may be provided the ability to require the consumer 20 to broadcast a live video stream via their mobile device 30 (or with the use of an additional external device such as a Samsung Project Beyond live streaming 360 degree stereoscopic virtual reality video camera system) using the report damages screen 724. For example, the desk adjuster may use a smart glass/smart helmet/VR goggles/wearable/holographic or other wearable viewing device or other external viewing device to review the video feed. The adjuster will direct the consumer 30 to film/broadcast the specific areas of damage. Close up content views may show needed detail for identification.

The adjuster may also direct the policyholder to scan barcodes on content items and the ARAII will automatically identify and catalog these damaged items. This may alleviate the need for an onsite visit by the adjuster. The contents desk adjuster may use a smart glass/smart helmet/VR goggles/wearable device to review the archived video/still pictures or panoramic photos, as well as 3D scans and light field camera acquisitions to start building a content estimate.

For exterior wind and hail damage, the desk adjuster can direct the policyholder to document the damaged sides of the structure and/or contents. As the consumer 20 documents the damage, the mobile device may measure the compass direction of view and catalog the wall elevation that is shown. The desk adjuster may order wall/roof reports from third party vendors and a damage estimate can be constructed. If the mobile device 30 is equipped with a 3-D scanner 119, the adjuster or the ARAII module 190 may pull in the dimensions of the wall and build the estimate accordingly.

In some embodiments, the claims process may be automated in part by utilizing the ARAII module 190 to identify the level and severity of damage. For example, the system 10 may use statistical classifiers to classify the level and severity of damage. The classification may include an estimate of the costs to repair the damage and to properly make the consumer 20 whole. This may permit the insurance company 80 to correctly assign the claim that will expedite claims settlement and enhance customer experience.

Using the report damages screen 724 and a loss capture screen 800, the consumer 20 may enter detailed information about the damaged asset, including any residential structure, detached structure, personal contents and scheduled items. FIG. 8A illustrates the loss capture screen 800 for the consumer 20 to document the losses incurred to the asset 40. The loss capture screen 800 may include a loss capture prompt 810 describing the portion of the asset 40 to document. Because the extent of the damage may be best identified by having easily compared loss documentation 850 to compare to the original asset information 45, the consumer 20 is prompted to capture loss documentation media 850 that is nearly identical to the original asset information 45. In an embodiment, loss documentation media 850 that is nearly identical to the original asset information 45 may include photos taken from approximately the same location, angle, and distance as the original. Alternatively, the loss documentation media 850 that is nearly identical to the original asset information 45 may include videos covering approximately the same path of travel, the same areas of focus, etc.

To capture the loss documentation 850, the loss capture screen 800 may also include a camera stream 720 or 3-D scan stream to display the current view from the camera 118 or 3-D scanner 119. To prompt the consumer 20 to capture media that is nearly identical to the original asset information 45, such as the photo view that was originally captured, the loss capture screen 700 may include a media prompt 815 derived from the original asset information 45.

For example, if the original asset information 45 was a photo, the media prompt 815 may be a prompt layer 820 overlaid over the camera stream 830 from the camera 118. The prompt layer 820, shown in detail in FIG. 8B, may be mostly transparent with the edges from the original asset information 45 retained in an outline. The prompt layer 820 may be overlaid over the camera stream 730 of FIG. 8C.

The prompt layer 820 may be generated by using an edge finding algorithm to find edges and color them black (or other conspicuous coloring) while leaving all other pixels transparent. In other embodiments, the prompt layers 820 may include the original hue values for each pixel, but overlay the pixels over the camera stream 830 with some level of transparency to permit the consumer 20 to view both the original photo of the original asset information 45 while simultaneously viewing the camera stream 830.

In another embodiment, the media prompt 815 may be placed side-to-side with the camera stream 830 with one or more reference markers located on both the media prompt 815 and the camera stream 830 in an identical pattern. The consumer 20 may manipulate the mobile device 30 until the items in image in the camera stream 830 line up with the same reference markers as shown on the media prompt 815. Further, it will be appreciated by those of skill in the art from the examples provided that the media prompt 815 may be provided to the consumer 20 in a variety of ways, including a variety of overlays, placement adjacent to the camera stream 830, etc.

Referring back to FIG. 7A, the consumer 20 may press the hotel and advance payment button 706 to view the name of the hotel, confirmation and contact information for any temporary housing needs. This hotel information may be retrieved from the asset verification servers 75 or the insurance company servers 85. In an embodiment, the insurance company's first notice of loss team may activate a claims processing system that obtains the hotel information. Additionally, pressing the hotel and advance payment button 706 may bring up advance payment information. The advance payment may be made to the policy holder using the mobile device 30, for example, the payment may be made via Apple® pay, Samsung® pay, Google® wallet, or a virtual debit card.

After a loss, the consumer 20 may press the alerts button 706 to view a list of alerts and action items regarding the claim. The alerts screen may include a short list of immediate responsibilities for the consumer 20, including:
i. A copy of the declaration page of the policy that stipulates the dollar amount of the policy coverage for the structure, detached structure, i.e. garage, pool etc., contents, scheduled items and additional living expenses.
ii. Request an advance payment to help with expenses you will incur because of this occurrence
iii. Refrain from signing any contracts or agreements with any company until you have talked with your insurance company or their adjuster
iv. If it is safe to enter building—gather any valuable items (money, jewelry, etc.) and sentimental items (family photo albums, etc.).
v. Confirm with your carrier whether they want you to secure the building.

The alerts screen may additionally provide access to a premium status report. For example, if the premium has not been received by the cut-off date from either the insured or the mortgage company, the application 70 will allow the insurance company 80 to send a push notification to advise the policyholder of the overdue payment status using her mobile device 30.

The consumer 20 may confirm that he or she wishes to secure the building by pressing a continue button that takes the consumer 20 to the resource screen. Alternatively, the consumer 20 may access the resources screen by pressing the resources button 710. In the resources screen, the consumer 20 may select a local or preferred vendor which will open up a list of companies in the area that handle securing a loss. Selecting a specific vendor from the list may open the vendor's website.

The consumer 20 may additionally access an E-workbook by pressing the E-workbook button 708. In the E-workbook, the consumer 20 may view videos and read other information that educates the consumer 20 about their policy and the claims process. The E-workbook may include a step-by-step introduction that guides the consumer 20 through the claims process as well as a step-by-step guide for how to use the application itself.

In some embodiments, the consumer 20 may additionally access a claims status report from the claims menu 700. The claims status option may be accessed by the insurance company 80, the insured consumer 20 and the repair contract vendors. All three parties may be able to communicate through this function using their own mobile device 30. The insurance company 80 and the vendor may be permitted to log progress updates on the repairs, request information from the insured consumer 20 and set alerts that require immediate attention from the insured consumer 20. The claims status report may also allow the insured consumer 20 to communicate directly with the insurance company 80 and the vendors with questions or concerns using her mobile device 30. This will reduce the stress of playing phone tag for all three parties and expedite claim settlement that will yield an exceptional customer experience. Also, to permit this communication, contract repair vendors may be able to download the app and access any claim in the API data base by entering the Claim # assigned by the carrier to access the communication functionality.

Referring back to FIG. 2A, the mobile device 30 may include a memory interface 102, controllers 103, such as one or more data processors, image processors and/or central processors, and a peripherals interface 106. The memory interface 102, the one or more controllers 103 and/or the peripherals interface 106 can be separate components or can be integrated in one or more integrated circuits. The various components in the mobile device 30 can be coupled by one or more communication buses or signal lines, as will be recognized by those skilled in the art.

Sensors, devices, and additional subsystems can be coupled to the peripherals interface 106 to facilitate various functionalities. For example, a motion sensor 108 (e.g., a gyroscope), a light sensor 110, and positioning sensors 112 (e.g., GPS receiver, accelerometer) can be coupled to the peripherals interface 106 to facilitate the orientation, lighting, and positioning functions described further herein. Other sensors 114 can also be connected to the peripherals interface 106, such as a proximity sensor, a temperature sensor, a biometric sensor, or other sensing device, to facilitate related functionalities.

A camera subsystem 116 and an optical sensor 118 (e.g., a charged coupled device (CCD) or a complementary metal-oxide semiconductor (CMOS) optical sensor) can be utilized to facilitate camera functions, such as recording photographs and video clips.

Communication functions can be facilitated through a network interface, such as one or more wireless communication subsystems 120, which can include radio frequency receivers and transmitters and/or optical (e.g., infrared) receivers and transmitters. The specific design and implementation of the communication subsystem 120 can depend on the communication network(s) over which the mobile device 30 is intended to operate. For example, the mobile device 30 can include communication subsystems 120 designed to operate over a GSM network, a GPRS network, an EDGE network, a Wi-Fi or Imax network, and a Bluetooth network. In particular, the wireless communication subsystems 120 may include hosting protocols such that the mobile device 30 may be configured as a base station for other wireless devices.

An audio subsystem 122 can be coupled to a speaker 124 and a microphone 126 to facilitate voice-enabled functions, such as voice recognition, voice replication, digital recording, and telephony functions.

The I/O subsystem 128 may include a touch screen controller 130 and/or other input controller(s) 132. The touch-screen controller 130 can be coupled to a touch screen 134, such as a touch screen. The touch screen 134 and touch screen controller 130 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 134. The other input controller(s) 132 can be coupled to other input/control devices 136, such as one or more buttons, rocker switches, thumb-wheel, infrared port, USB port, and/or a pointer device such as a stylus. The one or more buttons (not shown) can include an up/down button for volume control of the speaker 124 and/or the microphone 126.

The memory interface 102 may be coupled to memory 104. The memory 104 can include high-speed random access memory and/or non-volatile memory, such as one or more magnetic disk storage devices, one or more optical storage devices, and/or flash memory (e.g., NAND, NOR). The memory 104 may store operating system instructions 140, such as Darwin, RTXC, LINUX, UNIX, OS X, iOS, ANDROID, BLACKBERRY OS, BLACKBERRY 10, WINDOWS, or an embedded operating system such as VxWorks. The operating system instructions 140 may include instructions for handling basic system services and for performing hardware dependent tasks. In some implementations, the operating system instructions 140 can be a kernel (e.g., UNIX kernel).

The memory 104 may also store communication instructions 142 to facilitate communicating with one or more additional devices, one or more computers and/or one or more servers. The memory 104 may include graphical user interface instructions 144 to facilitate graphic user interface processing; sensor processing instructions 146 to facilitate sensor-related processing and functions; phone instructions 148 to facilitate phone-related processes and functions; electronic messaging instructions 150 to facilitate electronic-messaging related processes and functions; web browsing instructions 152 to facilitate web browsing-related processes and functions; media processing instructions 154 to facilitate media processing-related processes and functions; GPS/Navigation instructions 156 to facilitate GPS and navigation-related processes and instructions; camera instructions 158 to facilitate camera-related processes and functions; and/or other software instructions 160 to facilitate other processes and functions (e.g., access control management functions, etc.). The memory 104 may also store other software instructions controlling other processes and functions of the mobile device 30 as will be recognized by those skilled in the art. In some implementations, the media processing instructions 154 are divided into audio processing instructions and video processing instructions to facilitate audio processing-related processes and functions and video processing-related processes and functions, respectively. An activation record and International Mobile Equipment Identity (IMEI) 162 or similar hardware identifier can also be stored in memory 104.

Each of the above identified instructions and applications can correspond to a set of instructions for performing one or more functions described herein. These instructions need not be implemented as separate software programs, procedures, or modules. The memory 104 can include additional instructions or fewer instructions. Furthermore, various functions of the mobile device 30 may be implemented in hardware and/or in software, including in one or more signal processing and/or application specific integrated circuits. Accordingly, the mobile device 30, as shown in FIG. 2, may be adapted to perform any combination of the functionality described herein.

Aspects of the systems and methods described herein are controlled by one or more controllers 103. The one or more controllers 103 may be adapted run a variety of application programs, access and store data, including accessing and storing data in associated databases, and enable one or more interactions via the mobile device 30. Typically, the one or more controllers 103 are implemented by one or more programmable data processing devices. The hardware elements, operating systems, and programming languages of such devices are conventional in nature, and it is presumed that those skilled in the art are adequately familiar therewith.

For example, the one or more controllers 103 may be a PC based implementation of a central control processing system utilizing a central processing unit (CPU), memories and an interconnect bus. The CPU may contain a single microprocessor, or it may contain a plurality of microcontrollers 103 for configuring the CPU as a multi-processor system. The memories include a main memory, such as a dynamic random access memory (DRAM) and cache, as well as a read only memory, such as a PROM, EPROM, FLASH-EPROM, or the like. The system may also include any form of volatile or non-volatile memory. In operation, the main memory is non-transitory and stores at least portions of instructions for execution by the CPU and data for processing in accord with the executed instructions.

The one or more controllers 103 may further include appropriate input/output ports for interconnection with one or more output displays (e.g., monitors, printers, touchscreen 134, motion-sensing input device 108, etc.) and one or more input mechanisms (e.g., keyboard, mouse, voice, touch, bioelectric devices, magnetic reader, RFID reader, barcode reader, touchscreen 134, motion-sensing input device 108, etc.) serving as one or more user interfaces for the processor. For example, the one or more controllers 103 may include a graphics subsystem to drive the output display. The links of the peripherals to the system may be wired connections or use wireless communications.

Although summarized above as a PC-type implementation, those skilled in the art will recognize that the one or more controllers 103 also encompasses systems such as host computers, servers, workstations, network terminals, and the like. Further one or more controllers 103 may be embodied in a mobile device 30, such as a mobile electronic device, like a smartphone or tablet computer. In fact, the use of the term controller is intended to represent a broad category of components that are well known in the art.

Hence aspects of the systems and methods provided herein encompass hardware and software for controlling the relevant functions. Software may take the form of code or executable instructions for causing a processor or other programmable equipment to perform the relevant steps, where the code or instructions are carried by or otherwise embodied in a medium readable by the processor or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

1. A user interface system for providing insurance comprising:
a media capture unit including a camera;
a controller in communication with the media capture unit; and
a memory in communication with the controller;
wherein the memory includes first asset information previously captured by an asset verification process in which a user captures first visual media information including at least one visual media information including an asset shown from a perspective,
wherein the memory additionally including an asset verification software application that, when executed by the controller, causes the controller to:
in response to receiving a notification of a loss regarding the asset, prompt the user to capture second asset information using a media prompt including directions for capturing at least one image including a view of the asset from the perspective; and
transmit the second asset information to an underwriting server.

2. The system of claim 1, wherein the asset comprises a residential dwelling.

3. The system of claim 1, wherein the media capture unit further includes a 3-D scanner, wherein the first asset information includes a 3-D scan capturing geometry of the asset.

4. The system of claim 1, wherein the first asset information includes a panorama photo.

5. The system of claim 1, wherein, upon capturing the first asset information, the controller is adapted to:
classify the first asset information as sufficient or insufficient, wherein the first asset information is classified as sufficient upon successfully performing optical character recognition on a portion of the first asset information;
when the first asset information is classified as insufficient, prompt the consumer to capture a further asset information of the asset.

6. The system of claim 1, wherein, upon capturing the first asset information, the controller is adapted to:
execute a statistical classifier using the first asset information as an input to receive a classification;
when the classification identifies a risk factor, updating the asset information to include a data field listing the risk factor as present.

7. The system of claim 1, wherein, upon capturing the first asset information, the controller is adapted to:
execute a statistical classifier that analyzes visual media of the first asset information to identify an asset value property of the asset shown in the visual media;
updating the asset information to include a data field listing the asset value property.

8. The system of claim 1, wherein, during an asset verification process, the controller is adapted to:
prompt a user to capture first asset information regarding the asset using the media capture unit;
transmit the first asset information to an underwriting server in communication with the controller.

9. The system of claim 8, wherein the first asset information is captured by displaying an overlay prompt including an outline of the view to be collected, wherein the overlay prompt is displayed overlain over a camera stream.

10. The system of claim 1, wherein the overlay prompt includes a prompt to capture a manufacturer's label in the first asset information.

11. The system of claim 1, wherein the overlay prompt is an outline of a water heater.

12. The system of claim 1, wherein the overlay prompt is for an outline of an heating/cooling unit.

13. A user interface system for providing insurance comprising:
an asset verification server adapted to receive asset information from a mobile device, wherein, upon receiving the asset information, the asset verification server executes a statistical classifier that analyzes visual media to identify a class of risk shown in the visual media to assign a risk factor classification, wherein, the asset verification server updates the asset information to include a data field listing the risk factor classification, wherein, after updating the asset information, the asset verification server provides the updated asset information to an underwriting server; and
a mobile device comprising:
a media capture unit including a camera;
a controller in communication with the media capture unit; and
a memory in communication with the controller, the memory including an asset verification software application that, when executed by the controller, causes the controller to:
prompt a user to capture first asset information regarding the asset using the media capture unit;
transmit the first asset information to the asset verification server;
in response to receiving an offer from the underwriting server, display an offer screen including a quoted premium;
in response to receiving an acceptance of the offer from the user interface, transmit an acceptance to the underwriting server; and
in response to receiving a notification of a loss regarding the asset, prompt the user to capture second asset information using visual information derived from the first asset information.

14. The system of claim 13, wherein the controller is further configured to:
transmit the second asset information to an underwriting server as an insurance claim; and
in response to receiving acceptance of the insurance claim, displaying an acceptance of the insurance claim on the user interface.

15. The system of claim 13, wherein, upon capturing the first asset information, the controller is adapted to:
classify the first asset information as sufficient or insufficient, wherein the first asset information is classified as sufficient upon successfully performing optical character recognition on a portion of the first asset information;
when the first asset information is classified as insufficient, prompt the consumer to capture a further asset information of the asset.

16. The system of claim 13, wherein, upon capturing the first asset information, the controller is adapted to:
execute a statistical classifier using the first asset information as an input to receive a classification;
when the classification identifies a risk factor, updating the asset information to include a data field listing the risk factor as present.

17. The system of claim 13, wherein, upon capturing the first asset information, the controller is adapted to:
execute a statistical classifier that analyzes visual media of the first asset information to identify an asset value property of the asset shown in the visual media;
updating the asset information to include a data field listing the asset value property.

18. The system of claim 13, wherein, during the step of prompting a user to capture first asset information regarding the asset using the media capture unit, the controller is adapted to:
prompt a user to capture first asset information regarding the asset using the media capture unit;
transmit the first asset information to an underwriting server in communication with the controller.

19. The system of claim 18, wherein the first asset information is captured by displaying an overlay prompt including an outline of the view to be collected, wherein the overlay prompt is displayed overlain over a camera stream.

20. The system of claim 18, wherein the overlay prompt includes a prompt to capture a manufacturer's label in the first asset information.
